(19) United States
(12) Patent Application Publication
(10) Pub. No.: US 2010/0043295 A1
(43) Pub. Date: Feb. 25, 2010

(54) AUTOMATIC CABLE TENSIONER FOR CABLE DRIVE WINDOW REGULATORS

(76) Inventors: Geoffrey Barr, Troy, MI (US); Fred L. Sawgle, Lapeer, MI (US)

Correspondence Address: CANTOR COLBURN, LLP, 20 Church Street, 22nd Floor, Hartford, CT, 06103, US

(21) Appl. No.: 12/544,892

(22) Filed: Aug. 20, 2009

Related U.S. Application Data
(60) Provisional application No. 61/090,479, filed on Aug. 20, 2008.

(51) Int. Cl. E05F 15/10; E05F 11/06; E06B 3/00

(52) U.S. Cl. 49/352; 49/506

(57) ABSTRACT

A window glass assembly that automatically adjusts for variations in cable tension is provided. The window glass assembly includes a cable drum housing and at least one window cable extending from the housing for actuating a window. A first sleeve having ratchet teeth and an interior portion allows the window cable to pass through the sleeve. A first spring engages the first sleeve and a spring clip is retained in the cable drum housing and engages the ratchet teeth.

### CROSS REFERENCE TO RELATED APPLICATIONS

This application claims priority to U.S. Provisional Application Ser. No. 61/090,479, filed Aug. 20, 2008, the contents of which are incorporated by reference herein.

### BACKGROUND OF THE INVENTION

On present day vehicles, motorized window regulators are used extensively to provide a power window feature. Generally, assembly of a power window includes attaching cables to the window and to a cable drive for actuating the window. For proper operation, it is necessary that the window cable be tensioned upon installation. The prior art includes complicated and expensive cam pulleys to properly tension the cable.

In the design of a cable drive regulator for automotive moving windows, it is also a desirable and normal practice to provide spring tensioners. These spring tensioners are adapted to take out normal variation, wear and settlement in the cable and mechanism.

Currently, in the case of a conduited system, tensioners are often placed at the drive drum housing. A previously know system in this regard utilizes a two piece drive drum. In the specific case of a frameless glass system with a feature to reverse the glass prior to a vehicle door opening, accuracy of the reversal must be very tight, as specified by the original equipment manufacturer. Normally, adjustments cannot be made on the cable, which reverses the glass, due to the accuracy of the reversal. Therefore, there is a need to provide a mechanism to automatically adjust the cable to remove excessive slack, to prevent disengagement, and to eliminate excessive wear.

### SUMMARY OF THE INVENTION

The invention improves the cost, reliability and robustness of previously known window regulators by the use of a spring clip operating on a toothed sleeve. The invention is easy to assemble and pre-adjust, since a spring clip is inserted into the housing at the end of the assembly operation after the cable is placed over the pulleys.

According to one aspect of the invention, a window glass assembly that automatically adjusts for variations in cable tension is provided. The window glass assembly includes a cable drum housing and at least one window cable extending from the housing for actuating a window. A first sleeve having ratchet teeth and an interior portion allows the window cable to pass through the sleeve. A first spring engages the first sleeve and a spring clip is retained in the cable drum housing and engages the ratchet teeth. The entire assembly is retained in the drum housing by the spring clip retaining the drum housing to the ratchet teeth of the first sleeve.

According to another aspect of the invention, a method of adjusting the cable in a window drive assembly is provided. It includes providing a cable drum housing capable of winding at least one window cable and at least one cable extending from the cable drum. A first sleeve having ratchet teeth is threaded over the window cable and has ratchet teeth and an interior portion which fits over the window cable. The method further includes threading a first spring over the first sleeve and against a bearing surface on the first sleeve and inserting the first sleeve into an opening in the cable drum housing. The first sleeve and the cable drum housing are held together with a spring clip allowing for the tensioning of the window cable.

According to yet another aspect of the invention, a power window glass assembly that automatically adjusts for variations in cable tension is provided. The window glass assembly includes a cable drum housing, at least one window cable extending from the housing for actuating a window and a motor for winding the window cable. A first sleeve having ratchet teeth and an interior portion allows the window cable to pass through the sleeve. A first spring engages the first sleeve and a spring clip is retained in the cable drum housing and engages the ratchet teeth. The entire assembly is retained in the drum housing by the spring clip retaining the drum housing to the ratchet teeth of the first sleeve.

These and other advantages and features will become more apparent from the following description taken in conjunction with the drawings.

### BRIEF DESCRIPTION OF THE DRAWINGS

Other features, advantages and details appear, by way of example only, in the following description of embodiments, the description referring to the drawings in which:

FIG. 1 shows a window regulator system in a vehicle door frame;

FIG. 2 shows a cable drum housing in accordance with one aspect of the invention;

FIG. 3 shows an exploded view, in accordance with another aspect of the invention;

FIG. 4 shows yet another aspect of the invention;

FIG. 5 shows still yet another aspect of the present invention; and

FIG. 6 shows the window drive assembly of the invention in a tensioned position.

### DETAILED DESCRIPTION OF THE INVENTION

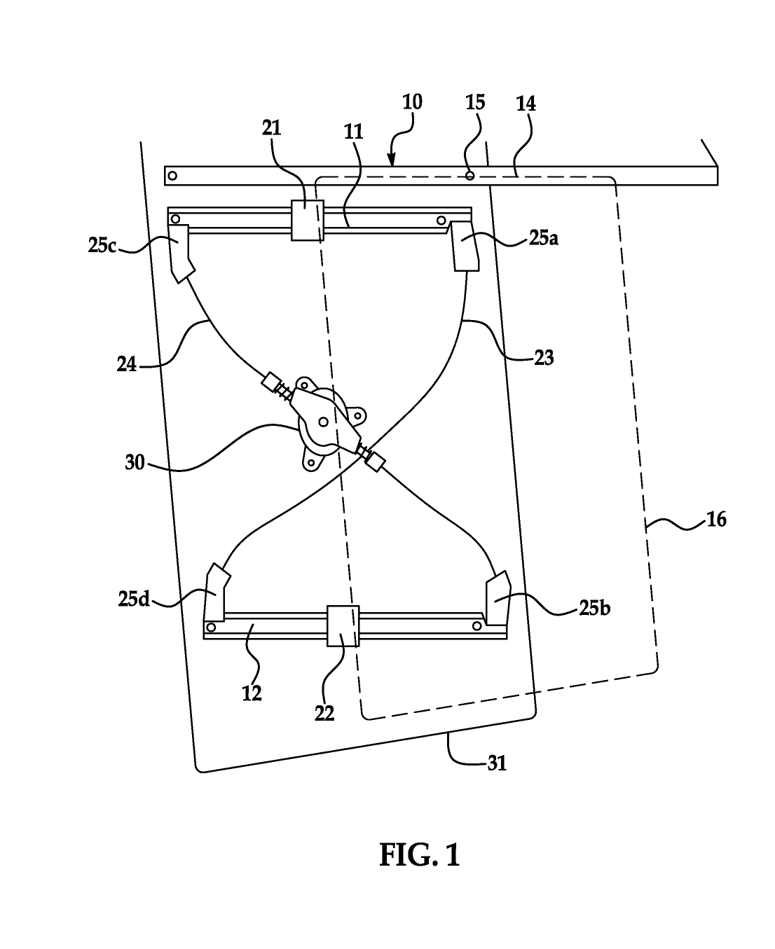

Referring now to the drawings, where the invention will be described with reference to specific embodiments, with limiting same, FIG. 1 shows a window glass assembly 10, including slide rails 11 and 12. A slide way 14 guides a front edge 15 of a window pane 16. A lower edge 20 of window pane 16, is fixed on two sliders 21 and 22. Thus, sliders, 21 and 22 slide respectively on rails 11 and 12 and parallel to slide way 14. A system of cables 23 and 24 are connected to sliders 21 and 22 pass around return pulleys 25a, 25b, 25c and 25d, provided that the upper and lower ends of guide rails 11 and 12 are connected to a cable drum housing 30 containing a cable drum (not shown) and a drive motor 39. The drive motor 39 allows cables 23 and 24 to be drawn in and out of cable drum housing 30 automatically to actuate a window between upper an lower positions, as in a power window glass assembly system. As is known, driving the cable drum 30 makes it possible to displace sliders 21 and 22, supporting window pane 16 and actuating window pane 16 between an open and a closed position within a doorframe 31.

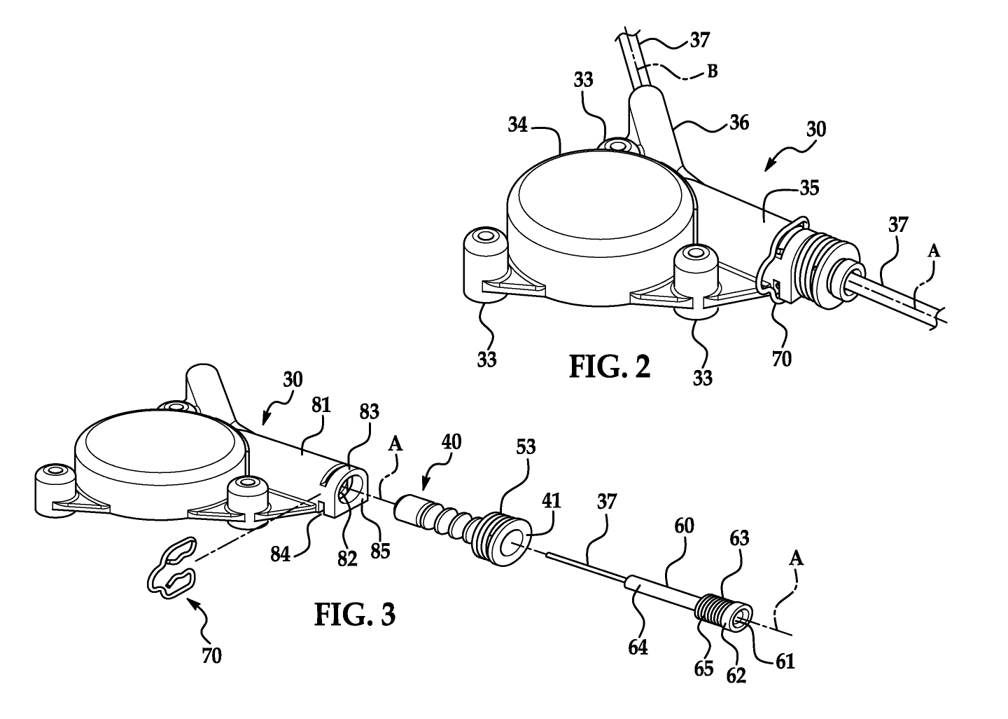

FIG. 2 shows the drum housing 30, shown as a molded plastic, in greater detail. Drum housing 30 is attached to doorframe 31 via attachment positions 33. Housing 30 includes a cable drum retaining portion 34, within which a cable drum (not shown), or multiple cable drums is contained, as is well known by one skilled in the art. Housing 30 includes a cable inlet portion 35 and a cable outlet portion 36. A window cable 37 winds into drum housing 30 along axis A, is wound about the cable drum within portion 34 and exits housing 30 at outlet portion 36 along axis B.

Referring now to FIGS. 3 and 5, a ratchet sleeve 40 is threaded over cable 37. Ratchet sleeve 40 has an interior sleeve portion 41 for receiving cable 37. The exterior annular surface 42 of sleeve 40 includes a series of ratchet teeth 43. Each tooth 43 includes a ramped portion 44 and a catch portion 45, the catch portion 45 is relatively orthogonal to axis A of sleeve 40. Ramped portion 44 and catch portion 45 terminate at a tooth end 46. Ramped portion 44 may comprise any number of angles, and need only be of sufficient depth to catch and retain portions of a spring clip 70 as will be discussed in detail herein. Sleeve 40 also includes a termination groove 47, and a spring shoulder portion 51, which includes a bearing surface 52. Interior sleeve portion 41 includes a spring seat 54, having an annular bearing surface 55, for purposes which will be described herein. It will be appreciated that sleeve 40 can be made of any of a number of suitable materials, such as molded plastic or machined steel.

As best seen in FIG. 3, spring shoulder portion 51 receives a heavy spring 53, for bearing against bearing surface 52. The assembly further includes a cable conduit 60 having an interior conduit portion 61 for receiving cable 37. Conduit 60 includes a spring shoulder 62 having a spring bearing surface 63 and an exterior annular portion 64, over which a compression spring 65 slides and bears against surface 63.

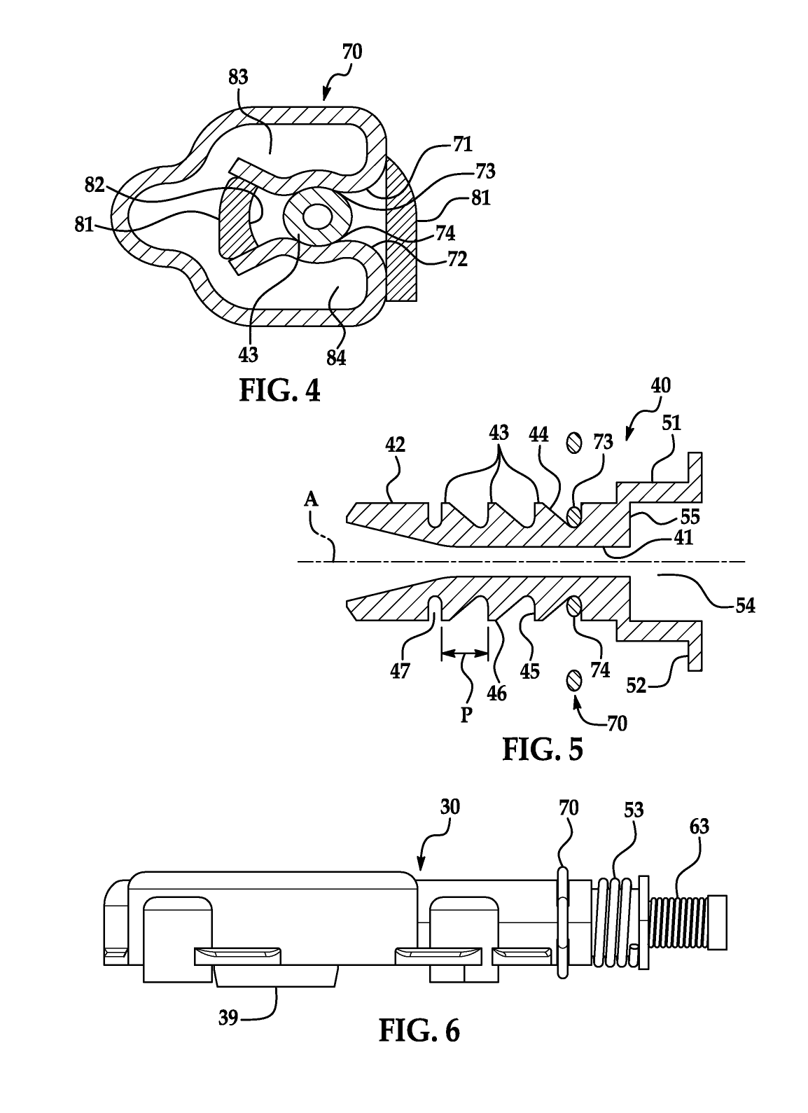

Referring now to FIG. 4, the spring clip 70 is shown as generally C-shaped and includes spring fingers 71 and 72. Spring fingers 71 and 72 include a concave portion 73 and 74, respectively, for capturing one of a series of ratchet teeth 43. It will be appreciated by one skilled in the art that spring clip 70 may take any one of numerous shapes for purposes that will be described herein. Included among these is a stamped spring steel construction having a shape, in profile, including a round, square or keystone construction. It will be appreciated that, whatever the shape, the profile shape is capable of cooperating with ramped portion 43 and ratchet teeth 44 of sleeve 40 in order that spring clip 70 retain sleeve 40 in a desired position.

Cable inlet portion 35 of housing 30 includes both an exterior surface 81 and an interior conduit 82 for receiving sleeve 40. Annular slots 83 and 84 extend between exterior surface 81 and interior conduit 82, allowing spring clip 70 to engage portion 35 and be retained thereon. As best seen in FIG. 4, fingers 73 and 74 bear against the edges of slots 83 and 84 and against ratchet teeth 43 in the assembled position.

In practice, and during assembly, drum housing 30 accepts cable 37 within interior conduit 82 in a tensioned state. Window cable 37 is threaded through conduit 60 and sleeve 40 and wound within drum housing 30. It will be appreciated that window cable 37 is frictionally retained within interior conduit portion 61, of cable conduit 60. In this state, ratchet sleeve 40 is inserted within conduit 82, so that spring 53 bears against a flanged surface 85, of inlet portion 35. Spring clip 70 is then inserted within retaining slots 83 and 84 to engage ratchet teeth 43 such as at a position as shown in FIG. 5. In this position, spring 53 can react to cable shock loads at stall and high temperatures. Spring fingers 73 and 74 are capable of riding up ramped portion 44 and over toothed end 46 to be retained against catch portion 45, thus constantly keeping cable 37 in a tensioned state.

Exterior annular portion 64, of cable conduit 60, extends within interior sleeve portion 41, of sleeve 40 while compression spring 65 is capable of bearing between the surface 63 and annular bearing surface 55. It will be appreciated the compression spring 65 is a lighter spring than spring 53 and acts in conjunction with spring 53 to further fine-tune movement of the assembly 10. The purpose of lighter spring 53 is to reduce the free play of window cable 37 to less than the ratchet pitch “P”, shown in FIG. 5, between adjacent ratchet teeth 43.

It will be appreciated that as the window pane 16 is adjusted between upper and lower positions, window cable 37 can be kept in tension by use of the invention, and tensioning can be adjusted at each cycle of the lift system assembly 10. The assembly 10, including the self adjusting cable of the invention is very robust and is capable of withstanding at least 120 pounds of force. The invention also allows the service assembly process to be simplified and made less expensive. In practice, spring clip 70 can be removed, thus allowing easy non-destructive disassembly and repair of the assembly system.

The invention provides the needed adjustment by the use of the spring clip operating on the ramped toothed sleeve. This allows the cable shock loads to be taken up by the ramped tooth sleeve at stall and at high temperatures. The mechanism operates to take up a cable free play, when the free play exceeds the tooth pitch of the sleeve.

The toothed sleeve is moved by the first heavy compression spring, which compresses the lighter spring to remove the free play. This deflects the spring clip, which engages in the next tooth of the sleeve. Therefore, free play is reduced to less than the ratchet pitch, as it is controlled by the second smaller compression spring. This operation takes place, as necessary, at each cycle of system.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A window glass assembly comprising:
a cable drum housing;
at least one window cable extending from said housing for actuating a window;
a first sleeve having ratchet teeth and an interior portion allowing said window cable to pass therethrough;
a first spring engaging said first sleeve; and
a spring clip retained in said cable drum housing and engaging said ratchet teeth.

2. The window glass assembly of claim 1, including a second sleeve engaging said first sleeve and having an interior portion for allowing said window cable to pass therethrough.

3. The window glass assembly of claim 2, including a second spring engaging said second sleeve.

4. The window glass assembly of claim 1, wherein said ratchet teeth of said first sleeve include a series of truncated cones, the apex of one of said series of truncated cones terminating in the base of one of an adjacent of said series of truncated cones.

5. The window glass assembly of claim 1, wherein said first sleeve includes a shoulder at one axial end of said sleeve, said first spring seating against said shoulder.

6. The window glass assembly of claim 5, wherein said first spring is retained between said cable drum housing and said shoulder of said first sleeve.

7. The window glass assembly of claim 3, wherein said second sleeve includes a shoulder at one axial end of said sleeve, said second spring seating against said shoulder of said second sleeve.

8. The window glass assembly of claim 7, wherein said second spring is retained between said first sleeve and said shoulder of said second sleeve.

9. The window glass assembly of claim 8, wherein said second spring has a smaller compression force relative to said first spring.

10. A method of adjusting the cable in a window drive assembly, said method comprising:
providing a cable drum housing capable of winding a window cable;
providing at least one cable extending from said cable drum;
threading a first sleeve having ratchet teeth and an interior portion over said window cable;
threading a first spring over said first sleeve and against a bearing surface on said first sleeve;
inserting said first sleeve into said cable drum housing;
engaging said first sleeve and said cable drum housing together with a spring clip; and
tensioning said window cable.

11. The method of claim 10, including threading a second spring over said window cable.

12. The method of claim 11, including threading a second sleeve over said window cable and sliding said second spring over said second sleeve and against a shoulder on said second sleeve.

13. The method of claim 12, including inserting an annular portion of said second sleeve into said interior portion of said first sleeve.

14. The method of claim 10, including threading a second sleeve over said window cable and said step of tensioning of said window cable includes drawing said first and said second sleeves into engagement.

15. A power window glass assembly system comprising:
a cable drum housing;
at least one window cable extending from said housing for actuating a window;
a motor for winding said window cable;
a first sleeve having ratchet teeth and an interior portion allowing said window cable to pass therethrough;
a first spring engaging said first sleeve; and
a spring clip retained in said cable drum housing and engaging said ratchet teeth.

16. The window glass assembly of claim 15, including a second sleeve engaging said first sleeve and having an interior portion for allowing said window cable to pass therethrough.

17. The window glass assembly of claim 16, including a second spring engaging said second sleeve.

18. The window glass assembly of claim 15, wherein said ratchet teeth of said first sleeve include a series of truncated cones, the apex of one of said series of truncated cones terminating in the base of one of an adjacent of said series of truncated cones.
